(19) United States
(12) Patent Application Publication
(10) Pub. No.: US 2006/0034667 A1
(43) Pub. Date: Feb. 16, 2006

(54) Drain sealing

(75) Inventors: David Charles Albone, Letchworth (GB); Robert James King, Hitchin (GB)

Correspondence Address: Richard A. Sharpe;PEARNE & GORDON, LLP, Suite 1200, 1801 East 9th St., Cleveland, OH, 44114, US

(73) Assignee: ACO Polymer Products, Inc.

(21) Appl. No.: 10/857,281

(22) Filed: May 28, 2004

(30) Foreign Application Priority Data
May 30, 2003 (GB) 0312464.1

(51) Int. Cl. E21D 9/06; F16L 55/18

(52) U.S. Cl. 405/184.2; 405/146; 405/184.5

(57) ABSTRACT

Plastic liner sections (2) define a drainage channel when placed end to end. Each end (6,8) has a stiff, double walled flange (34) at each side of the end adapted to butt up to a similar flange (34) at the adjacent end of the next sections (2). The double walled construction of the flanges (34) stiffens the ends (6,8) significantly reducing the risk of deformation by the hydrostatic forces produced by wet concrete during installation. A groove (24) is formed inwardly of the flanges (34) on a female end (6) of the liner section (2) and receives a sealing ring (52), which is held in place by a lip (26) formed on a male end (8).

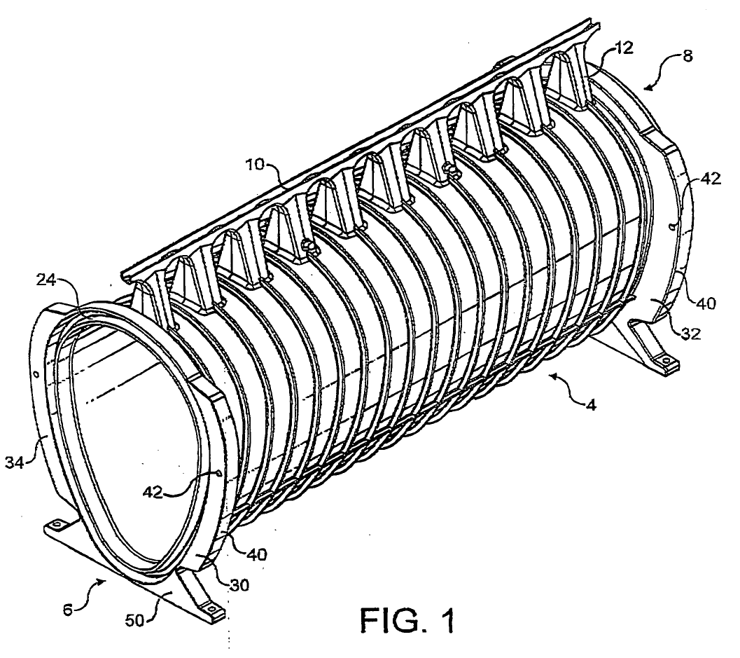

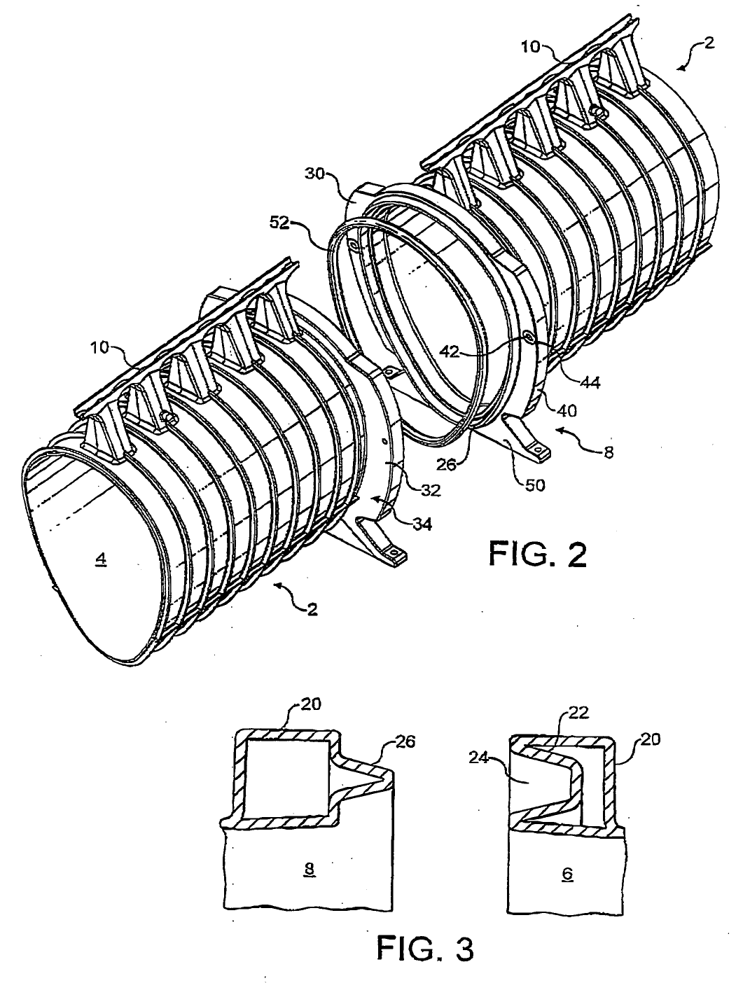

### BACKGROUND OF THE INVENTION

The present invention relates to the sealing of channel drainage systems, and more specifically to the seating of high capacity channels typically referred to as wide channel drainage systems.

### TECHNICAL PROBLEM

Robust drainage channels with a high hydraulic capacity are required for surface drainage in large areas such as distribution centres, car parks, airports and farm yards. The water carried in the drains from such surfaces will inevitably carry environmental pollutants such as hydrocarbons, pesticides, organic effluents and milk. It is therefore important to prevent such water from leaking out of the drain into the surrounding sub-soil where it may contaminate ground water supplies and produce other harmful environmental effects such as eutrophication. Natural stormwater leaking from the drainage system into surrounding contaminated land may also disturb and mobilise any latent toxins that may reside in the soil, particularly on brownfield site applications.

Polymer concrete U shaped channel drain sections are typically joined by being butted together end to end to form a channel. These joints are not water tight and the concrete haunch is relied upon to prevent leakage into the surrounding sub-soil. Escaping water may erode and therefore weaken the concrete. Where sealing is required sealing compounds are used.

Zurn Industries, Inc. in U.S. Pat. No. 6,000,881 describes a modular polymeric trench drain system in which the modules act as both former and liner. The Zurn modules define a U shaped channel section terminating in a restricted throat defining a slot drain at the surface. Zurn describes the technical problem of pressure from wet concrete against the trench drain walls causing deformation during installation. Flanges are formed at each end of the modules to facilitate joining of the sections. At one end the flange has a peripheral groove member to form a female section that mates with a male section on an adjacent flange of the next module section. In an alternative embodiment the flanges are omitted and a lip serves as a male section for engaging into a female section that is not illustrated

GB-A-2 373 530 (ACO Technologies plc) describes a wide channel drainage system in which plastics channel liner sections each defining a complete pipe section are connected to form a continuous channel. In that specification it is taught to interlock the channels by means of male and female connection details at opposite ends. However since the sections have no significant structural strength and are lightweight, it has been found that an unacceptable deformation occurs at the weaker, male end of the channel section. This is due to the hydrostatic forces exerted by the wet concrete surrounding the channel section.

Although Zurn acknowledges the technical problem of channel section deformation, the only solution proposed is the provision of clips to allow reinforcing and support rods to be held in horizontal and vertical axes at either side of the sections. This leaves the ends vulnerable.

### SOLUTION OF THE INVENTION

The present invention accordingly provides a plastics liner section for defining a drainage chanel when placed end to end, each end having a flange at each side of the end adapted to butt up to a similar flange at the adjacent end of the next section, characterised in that the flanges are each defined by two spaced wall portions joined together by a side wall. Such double walled flanges are stiffer than the single wall flanges of Zurn and are therefore capable of resisting the concrete forces. The flanges therefore provide a face sealing arrangement as with polymer concrete U shaped channel sections.

A single flange may extend all round a lower part of the end of the section, but the flanges are preferably constructed as separate wings on each side of the end.

Preferably a hollow box section surrounds each end of the liner section in order to use of a double walled construction. A box section 20 surrounds each end 6, 8. At the female and 6 a front face 22 of the box section 20 is indented to provide a deep groove 24. A lip 26 is formed on the box section 20 at the male end 8.

At both ends 6, 8, spaced parallel wall portions 30, 32 project at each side of the open end 6, 8 in order to define flanges like wings 34 on either side of the end. The wall portions 30, 32 are joined together by a side wall 40 so that the wings 34 are hollow and light weight but much stiffer than the remainder of the liner section 2.

Aligned openings 42 are formed in each of the walls 30 and 32 to enable a screwed fixing (not shown) to pass through both adjacent flanges 34 when they are butted together in order to hold them in position if desired. A depression 44 surround the opening 42 in wall 30 of the male end 8 in order to accommodate a washer (not shown).

The wings 34 are shown as separate features on each side of the ends 6, 8 but may be formed as part of a single flange extending around the whole of a lower portion of the pipe portion 4. This may be convenient when the liner sections 2 are intended to be top hung in a trench and a levelling base 50 is not required. The base 50 is also preferably formed of the same double skinned constructions as the flanges 34.

An annular seal 52 of ethylene propylene diene monomer (EDPM) or neoprene is inserted between the ends 6, 8. The seal is preferably a donut section with a hollow center to allow easy compressability to absorb tolerance variations on length. The seal 54 is trapped in the groove 24 by means of the lip 26.

In use the liner sections 2 are placed in a trench and connected together. Seals 52 are placed between adjacent ends. The wings 34 may be fastened together through holes 42 to keep them in position during the concrete pour. The screwed fixing can also be tightened to control the compression applied to the seal 52 between the sections 2.

What is claimed is:

1) A plastics liner section (2) for defining a drainage channel when placed end to end, each end (6,8) having a flange (34) at each side of the end adapted to butt up to a similar flange (34) at the adjacent end of the next section (2), characterised in that the flanges (34) are each defined by two spaced wall portions (30,32) joined together by a side wall (40).

2) A plastics liner section as claimed in claim 1, characterised in that a single flange extends around a lower portion of each end.

3) A plastics liner section as claimed in claim 1, characterised in that the flanges are constructed as separate wings on each side of the end.

4) A plastics liner section as claimed in any one of the preceding claims, characterised in that a hollow box section (20) surrounds each end of the liner section (2).

5) A plastics liner section as claimed in any one of the preceding claims, characterised in that a lip (26) is formed at one end (8) inside the flange (34) and a groove (24) at the other end (6).

6) A plastics liner section as claimed in claim 5, characterised in that the lip (26) and groove (24) are each supported on a box section (20) that surround the end of the liner section (2).

7) A plastics liner section as claimed in claim 5 or 6, characterised in that the groove (24) is sized to receive a hollow annular seal (52), which is retained in place by the lip (26).

8) A plastics liner section substantially as herein described with reference to the accompanying drawings
